(19) United States
(12) Patent Application Publication
(10) Pub. No.: US 2004/0207214 A1
(43) Pub. Date: Oct. 21, 2004

(54) Electronic door lock

(76) Inventor: Yi-An Lin, Chia Yi City (TW)

Correspondence Address: BAKER BOTTS LLP, C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 10/414,084

(22) Filed: Apr. 16, 2003

(51) Int. Cl. E05B 3/00

(52) U.S. Cl. 292/336.3

(57) ABSTRACT

In an electric door lock, a spindle with a rotary knob is connected operably to a deadbolt, and has a coupling ring sleeved co-rotatably thereon, and a rotary seat sleeved rotatably thereon. The rotary seat has a clutch portion surrounded by a stationary seat and provided with a resilient locking unit that normally engages the stationary seat, and that is normally disengaged from the coupling ring to permit operation of the rotary knob to rotate the spindle. A motor has a shaft coupled to the rotary seat. The locking unit is disengaged from the stationary seat and engages the coupling ring when the motor is operated to rotate the rotary seat, thereby resulting in co-rotation of the spindle. When the locking unit is disengaged from the stationary seat, the locking unit can be disengaged from the coupling ring once the rotary knob is operated to rotate the spindle.

### BACKGROUND OF THE INVENTION

1. Field of the Invention

The invention relates to an electronic door lock, more particularly to an electronic door lock which is operable both manually and electrically.

2. Description of the Related Art

In U.S. Pat. No. 6,471,257, there is disclosed an electric door lock that includes a deadbolt mounted in a lock housing and movable between locking and unlocking positions. A manual operating member is mounted on the lock housing, has a spindle that extends into the lock housing and that is connected to the deadbolt, and a manually operable knob that is secured to one end of the spindle and that is disposed externally of the lock housing. A spindle coupling ring is sleeved on the spindle so as to be co-rotatable therewith, and has an outer peripheral surface formed with angularly displaced first locking grooves. A rotary seat has a gear portion that is sleeved rotatably on the spindle, and a clutch portion that is connected fixedly and co-axially to the gear portion. The clutch portion is disposed around the spindle coupling ring, has an outer surface opposite to the inner surface, and is formed with mounting holes which correspond to the first locking grooves in the spindle coupling ring. Each of the mounting holes has an open inner hole end formed at the inner surface, and an open outer hole end formed at the outer surface. A stationary seat is disposed within and is secured to the lock housing, and has a ring portion which is disposed around the clutch portion and which has an annular inner peripheral surface confronting the outer surface of the clutch portion. The inner peripheral surface is formed with angularly displaced second locking grooves. Resilient locking units are mounted respectively in the mounting holes, each of which has a locking member. Each locking member has an inner locking portion that is disposed at the inner hole end of the respective mounting hole, and an outer locking portion that is disposed at the outer hole end of the respective mounting hole. The locking members are normally disposed in a first position, in which the outer locking portion of the locking member projects radially and outwardly from the outer surface of the clutch portion and engages a respective one of the second locking grooves in the stationary seat for locking the rotary seat to the stationary seat, and in which the inner locking portion of the locking member is retracted into the respective mounting hole and is disengaged from the first locking grooves in the spindle coupling ring for unlocking the rotary seat from the spindle coupling ring. The rotary knob is operable to rotate the spindle for moving the deadbolt between the locking and unlocking positions when the locking members are disposed in the first position. An electric driving motor has a transmission shaft coupled to the gear portion of the rotary seat, and is operable to drive rotation of the rotary seat for moving the locking members to a second position, in which the outer locking portion of each locking member slides past the respective one of the second locking grooves and is disengaged from the respective one of the second locking grooves for unlocking the rotary seat from the stationary seat, and in which the inner locking portion of each locking member projects from the inner surface of the clutch portion and engages a respective one of the first locking grooves in the spindle coupling ring for locking the rotary seat to the spindle coupling ring, thereby enabling co-rotation of the spindle for moving the deadbolt between the locking and unlocking positions.

The aforementioned conventional electric door lock indeed achieves its intended purpose of moving the deadbolt to locking and unlocking positions both electrically and manually. However, when power supply to the electric door lock is interrupted while the electric driving motor drives rotation of the rotary seat, the resilient locking units in the aforementioned conventional electric door lock do not permit forced movement of the spindle coupling ring relative to the rotary seat. In other words, the deadbolt is immovable manually at this time. As such, when the deadbolt has yet to be unlocked, there is a risk of persons being trapped in the event of power interruption.

### SUMMARY OF THE INVENTION

Therefore, the object of the present invention is to provide an electric door lock that is operable both manually and electrically and that can overcome the aforesaid drawback of the prior art.

According to the present invention, an electric door lock comprises a deadbolt, a manual operating member, a spindle coupling ring, a rotary seat, a stationary seat, an electric driving motor, and a resilient locking unit. The deadbolt is movable between locking and unlocking positions. The manual operating member has a deadbolt operating spindle connected to the deadbolt, and a manually operable rotary knob secured to one end of the spindle. The spindle coupling ring is sleeved on the spindle so as to be co-rotatable therewith, and has an annular outer peripheral surface formed with a plurality of first locking grooves. Each of the first locking grooves is displaced angularly from an adjacent one of the first locking grooves by a predetermined angle with respect to an axis of the spindle. The rotary seat has a gear portion sleeved rotatably on the spindle, and an annular clutch portion connected co-axially to the gear portion. The clutch portion is disposed around the spindle coupling ring, and has an inner surface confronting the spindle coupling ring, and an outer surface opposite to the inner surface. The clutch portion is formed with a mounting hole. The mounting hole has an open inner hole end formed in the inner surface, and an open outer hole end formed in the outer surface. The stationary seat has a ring portion which is disposed around the clutch portion and which has an annular inner peripheral surface confronting the outer surface of the clutch portion. The inner peripheral surface is formed with a plurality of second locking grooves. Each of the second locking grooves is displaced angularly from an adjacent one of the second locking grooves by the predetermined angle with respect to the axis of the spindle. The electric driving motor is coupled to the gear portion of the rotary seat. The resilient locking unit is mounted in the mounting hole in the clutch portion, and includes a seat body, an outer arc member, a first spring member, an inner arc member, and a second spring member. The seat body is movably disposed in the mounting hole. The outer arc member is disposed in the mounting hole on one side of the seat body adjacent to the outer hole end. The first spring member serves to bias the seat body in a radial outward direction in the mounting hole. The inner arc member is disposed in the mounting hole on an opposite side of the seat body adjacent to the inner hole end. The second spring member serves to bias the inner arc member in a radial inward direction in the mounting hole away from the seat body.

The first spring member biases the seat body so as to dispose the outer arc member in a first position, where the outer arc member projects radially and outwardly relative to the outer surface of the clutch portion and engages one of the second locking grooves in the stationary seat for locking the rotary seat to the stationary seat, and where the inner arc member is retracted into the mounting hole and is disengaged from the first locking grooves in the spindle coupling ring for unlocking the rotary seat from the spindle coupling ring, thereby permitting operation of the rotary knob to rotate the spindle for moving the deadbolt between the locking and unlocking positions.

The electric driving motor is operable to drive rotation of the rotary seat for moving the outer arc member to a second position, in which the outer arc member slides out of said one of the second locking grooves and moves along the inner peripheral surface of the stationary seat so that the seat body moves toward the inner hole end of the mounting hole against biasing action of the first spring member to cause the inner arc member to project from the inner surface of the clutch portion and engage one of the first locking grooves in the spindle coupling ring for locking the rotary seat to the spindle coupling ring, thereby enabling co-rotation of the spindle with the rotary seat for moving the deadbolt between the locking and unlocking positions.

When the outer arc member is disposed at the second position, the manual operating member is operable, such as in the event of power interruption, so as to drive rotation of the spindle coupling ring for enabling the inner arc member to move out of said one of the first locking grooves and to slide along the outer peripheral surface of the spindle coupling ring against biasing action of the second spring member.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of the preferred embodiment of an electric door lock according to the present invention;

FIG. 2 is a sectional view of the preferred embodiment in an assembled state illustrating a locking unit disposed in a first state;

FIG. 3 is a fragmentary sectional view illustrating the locking unit disposed in the first state;

FIG. 4 is a fragmentary sectional view illustrating the locking unit disposed in a second state; and

FIG. 5 is a fragmentary sectional view to illustrate how a deadbolt can be moved between locking and unlocking positions when an electric drive motor is inoperative.

### DETAILED DESCRIPTION OF THE PREFERRED EMBODIMENT

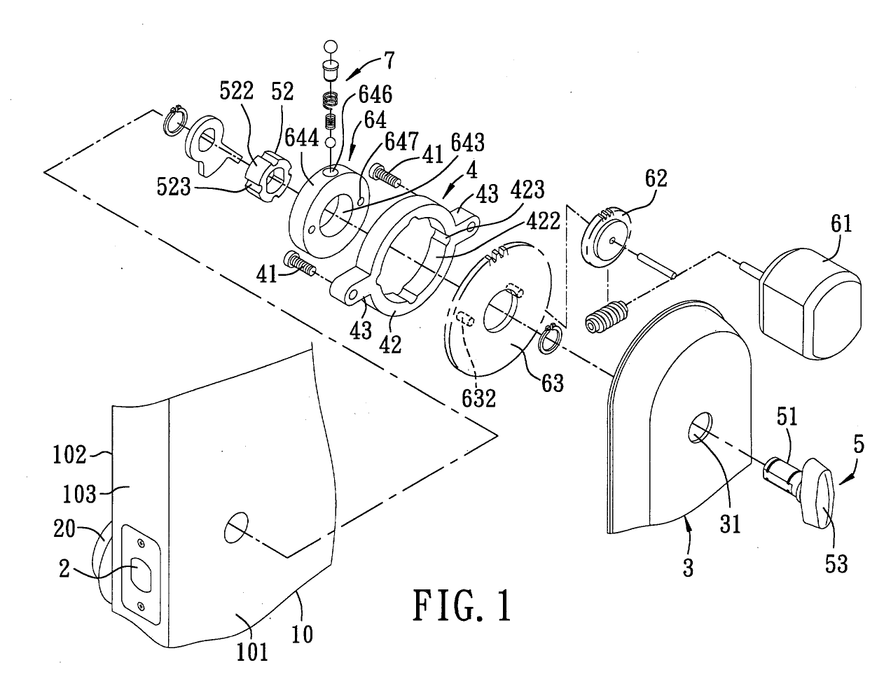

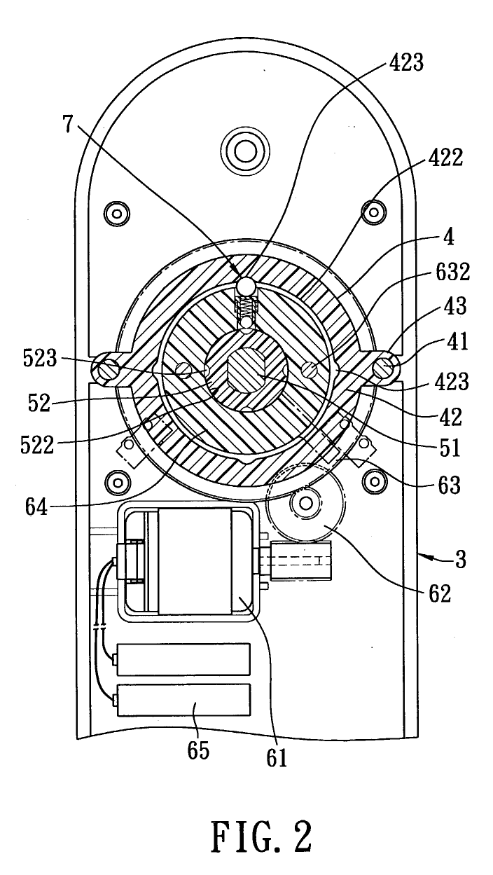

Referring to FIGS. 1 to 3, the preferred embodiment of an electric door lock for locking and unlocking a door panel 10 on a door frame (not shown) according to the present invention is shown to include a deadbolt 2, a manual operating member 5, a spindle coupling ring 52, a rotary seat, a stationary seat 4, an electric driving motor 61, and a resilient locking unit 7.

The door panel 10 has an inner surface 101, an outer surface 102, and a peripheral surface 103 that interconnects the inner and outer surfaces 101, 102.

A lock housing 3 is mounted on the inner surface 101 of the door panel 10, and is formed with a spindle hole 31 therethrough.

The deadbolt 2 is conventional in construction, is mounted in the door panel 10 and is operable to move between a locking position, in which the deadbolt 2 projects from the peripheral surface 103 of the door panel 10 so as to be adapted to engage the door frame, and an unlocking position, in which the deadbolt 2 is retracted into the peripheral surface 103 of the door panel 10 so as to be adapted to disengage from the door frame.

A key-operated lock unit 20 is mounted on the outer surface 102 of the door panel 10, and is coupled to the deadbolt 2. By operating the lock unit 20 with a corresponding key (not shown), the deadbolt 2 can be moved between the locking and unlocking positions. Since the feature of the present invention does not reside in the particular configuration of the lock unit 20, which is conventional in construction, a detailed description of the same is omitted herein for the sake of brevity.

The manual operating member 5 has a deadbolt operating spindle 51 that extends rotatably into the lock housing 3 through the spindle hole 31. The spindle 51 has an inner end that is connected to the deadbolt 2 for moving the deadbolt 2 between the locking and unlocking positions, and an outer end that is disposed externally of the lock housing 3. A manually operable rotary knob 53 is secured to the outer end of the spindle 51.

The spindle coupling ring 52 is sleeved on the spindle 51 so as to be co-rotatable therewith, and has an annular outer peripheral surface 522 that is formed with four angularly displaced first locking grooves 523. Each of the first locking grooves 523 is displaced angularly from an adjacent one of the first locking grooves 523 by a predetermined angle with respect to an axis of the spindle 51.

The rotary seat has a gear portion 63 and an annular clutch portion 64. The gear portion 63 is sleeved rotatably on the spindle 51, and has a periphery formed with gear teeth. The clutch portion 64 is connected co-axially to the gear portion 63, is disposed around the spindle coupling ring 52, has an inner surface 643 confronting the spindle coupling ring 52 and an outer surface 644 opposite to the inner surface 643, and is formed with a mounting hole 646.

The mounting hole 646 extends in a radial direction through the clutch portion 64 and, has an open inner hole end that is formed in the inner surface 643 and an open outer hole end that is formed in the outer surface 644. In this embodiment, the mounting hole 646 has a larger diameter portion proximate to the outer hole end, a smaller diameter portion proximate to the inner hole end, and a shoulder portion 648 between the larger diameter portion and the smaller diameter portion. Preferably, one side of the gear portion 63 is formed with a pair of pins 632, and one side of the clutch portion 64 is formed with a pair of pinholes 647 to engage the pins 632. In a modified embodiment, the gear and clutch portions 63, 64 are formed integrally.

The stationary seat 4 is mounted in the lock housing 3, and has a ring portion 42 which is disposed around the clutch portion 64 and which has an annular inner peripheral surface 422 confronting the outer surface 644 of the clutch portion 64. The inner peripheral surface 422 is formed with four angularly displaced second locking grooves 423. Each of the second locking grooves 423 is displaced angularly from an adjacent one of the second locking grooves 423 by the predetermined angle with respect to the axis of the spindle 51. In this embodiment, the ring portion 42 of the stationary seat 4 is formed with a pair of radial lugs 43. The lugs 43 are formed with fastener holes therethrough. The lock housing 3 is formed with a pair of threaded holes (not shown) corresponding to the fastener holes in the lugs 43. Screw fasteners 41 are inserted respectively through the fastener holes in the lugs 43 and are threaded into the threaded holes in the lock housing 3.

The electric driving motor 61 is mounted in the lock housing 3, and has a transmission shaft. A transmission gear 62 is mounted rotatably in the lock housing 3, is coupled to the transmission shaft, and has gear teeth that mesh with the gear teeth of the gear portion 63 of the rotary seat. Batteries 65 are coupled electrically and provide power to the electric driving motor 61.

The resilient locking unit 7 is mounted in the mounting hole 646 in the clutch portion 64, and includes a seat body 71, an outer arc member 72, a first spring member 75, an inner arc member 73, and a second spring member 74.

The seat body 71 is movably disposed in the mounting hole 646, and includes a support plate 711 that is disposed in the larger diameter portion, and a guide shank 712 that extends from the support plate 711, through the shoulder portion 648 and into the smaller diameter portion. The guide shank 712 is tubular, and has a constricted open end portion 714 proximate to the inner hole end.

The outer arc member 72 is disposed in the mounting hole 646 on one side of the seat body 71 adjacent to the outer hole end, and abuts against the support plate 711.

The first spring member 75 serves to bias the seat body 71 in a radial outward direction in the mounting hole 646, and includes a coil spring that is sleeved on the guide shank 712 and that has opposite ends abutting against the support plate 711 and the shoulder portion 648, respectively.

The inner arc member 73 is disposed in the mounting hole 646 on an opposite side of the seat body 71 adjacent to the inner hole end. Preferably, both of the inner and outer arc members 72, 73 are ball members.

The second spring member 74 serves to bias the inner arc member 73 in a radial inward direction in the mounting hole 646 away from the seat body 71, includes a coil spring that is disposed in the guide shank 712 and that has opposite ends abutting against the support plate 711 and the inner arc member 73, respectively, and has a spring force that is sufficient to ensure engagement between the inner arc member 73 and the spindle coupling ring 52 when the electric driving motor 61 is operated so as to drive rotation of the rotary seat (to be described in greater detail in the succeeding paragraphs). The spring force of the second spring member 74 is larger than that of the first spring member 75.

Although the electric door lock of this invention is exemplified using only one locking unit 7, it should be apparent to those skilled in the art that the number of the locking unit 7 may be increased to meet actual requirements.

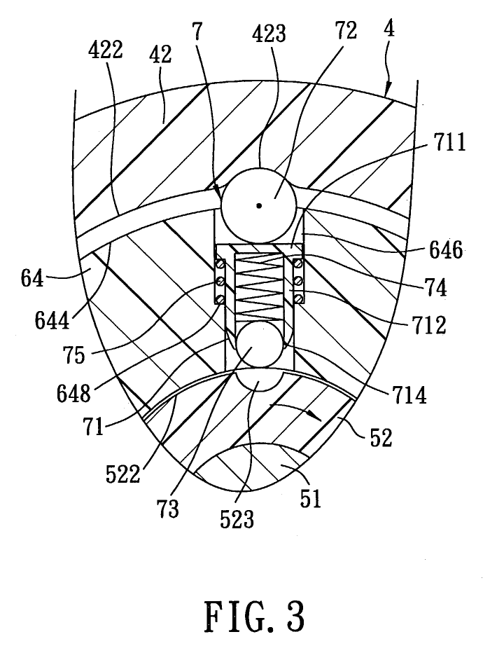

Normally, as best shown in FIG. 3, the first spring member 75 biases the seat body 71 so as to dispose the outer arc member 72 in a first position, where the outer arc member 72 projects radially and outwardly relative to the outer surface 644 of the clutch portion 64 and engages one of the second locking grooves 423 in the stationary seat 4 for locking the clutch portion 64 to the stationary seat 4, and where the inner arc member 73 is retracted into the mounting hole 646, is gripped releasably by the constricted open end portion 714 of the guide shank 712, and is disengaged from the first locking grooves 523 in the spindle coupling ring 52 for unlocking the rotary seat from the spindle coupling ring 52. In other words, the rotary seat is normally locked to the stationary seat 4 and is normally unlocked from the spindle coupling ring 52, thereby permitting operation of the rotary knob 53 to rotate the spindle 51 for moving the deadbolt 2 between the locking and unlocking positions.

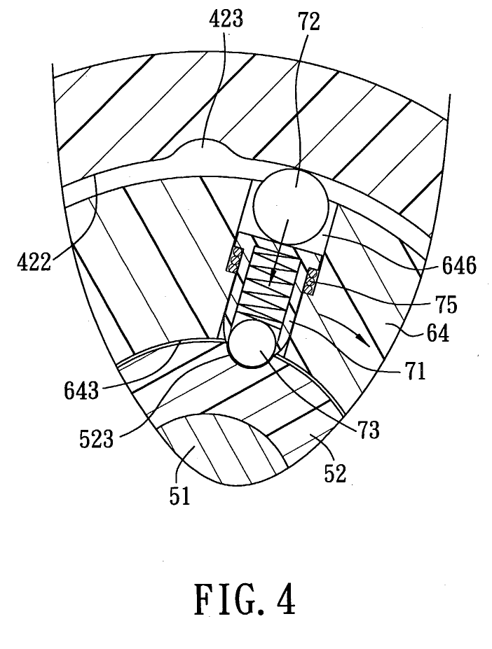

With further reference to FIG. 4, the electric driving motor 61 is operable to drive rotation of the clutch portion 64 through the transmission gear 62 and the gear portion 63 (see FIG. 1) for moving the outer arc member 72 to a second position, in which the outer arc member 72 slides out of an initial one of the second locking grooves 423 and moves along the inner peripheral surface 422 of the stationary seat 4 so that the seat body 71 moves toward the inner hole end of the mounting hole 646 against biasing action of the first spring member 75 to cause the inner arc member 73 to project from the inner surface 643 of the clutch portion 64 and engage one of the first locking grooves 523 in the spindle coupling ring 52 for locking the clutch portion 64 to the spindle coupling ring 52, thereby enabling co-rotation of the spindle 51 with the rotary seat for moving the deadbolt 2 between the locking and unlocking positions. A known switch mechanism (not shown) is employed so that the operation of the electric driving motor 61 automatically stops when the outer arc member 72 engages a succeeding one of the second locking grooves 423.

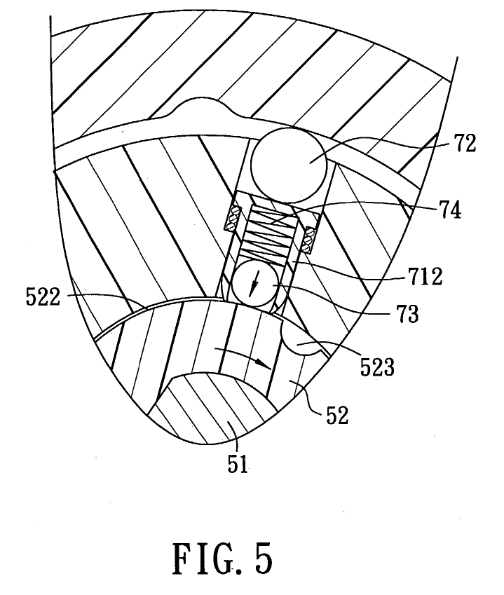

With further reference FIG. 5, when the outer arc member 75 is disposed at the second position and the electric drive motor 61 is unable to operate further due to insufficient battery power, the manual operating member 5 can be operated, using a relatively larger applied force, to drive rotation of the spindle coupling ring 52. This enables the inner arc member 73 to move out of an initial one of the first locking grooves 523, to be forced into the guide shank 712 against the biasing action of the second spring member 74, and to slide along the outer peripheral surface 522 of the spindle coupling ring 52 against biasing action of the second spring member 74. Accordingly, rotation of the spindle 51 for moving the deadbolt 2 between the locking and unlocking positions is still permitted to avoid the possibility of persons being trapped when the electric driving motor 61 is inoperative.

It has thus been shown that, in the electric door lock of the present invention, the manual operating member 5 is operable regardless of whether the outer arc member 72 is disposed in the first or second position. As such, manual operation of the rotary knob 53 to rotate the spindle 51 for moving the deadbolt 2 between the locking and unlocking positions is permitted even when the electric drive motor 61 is inoperative.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electric door lock comprising:
a deadbolt movable between locking and unlocking positions;
a manual operating member having a deadbolt operating spindle that is connected to said deadbolt, and a manually operable rotary knob that is secured to one end of said spindle;
a spindle coupling ring sleeved on said spindle so as to be co-rotatable therewith, said spindle coupling ring having an annular outer peripheral surface formed with a plurality of first locking grooves, each of said first locking grooves being displaced angularly from an adjacent one of said first locking grooves by a predetermined angle with respect to an axis of said spindle;
a rotary seat having a gear portion sleeved rotatably on said spindle, and an annular clutch portion connected co-axially to said gear portion, said clutch portion being disposed around said spindle coupling ring, and having an inner surface confronting said spindle coupling ring, and an outer surface opposite to said inner surface, said clutch portion being formed with a mounting hole, said mounting hole having an open inner hole end formed in said inner surface and an open outer hole end formed in said outer surface;
a stationary seat having a ring portion which is disposed around said clutch portion and which has an annular inner peripheral surface confronting said outer surface of said clutch portion, said inner peripheral surface being formed with a plurality of second locking grooves, each of said second locking grooves being displaced angularly from an adjacent one of said second locking grooves by the predetermined angle with respect to the axis of said spindle;
an electric driving motor coupled to said gear portion of said rotary seat; and
a resilient locking unit mounted in said mounting hole in said clutch portion, said resilient locking unit including
a seat body movably disposed in said mounting hole,
an outer arc member disposed in said mounting hole on one side of said seat body adjacent to said outer hole end,
a first spring member for biasing said seat body in a radial outward direction in said mounting hole,
an inner arc member disposed in said mounting hole on an opposite side of said seat body adjacent to said inner hole end, and
a second spring member for biasing said inner arc member in a radial inward direction in said mounting hole away from said seat body;
wherein said first spring member biases said seat body so as to dispose said outer arc member in a first position, where said outer arc member projects radially and outwardly relative to said outer surface of said clutch portion and engages one of said second locking grooves in said stationary seat for locking said rotary seat to said stationary seat, and where said inner arc member is retracted into said mounting hole and is disengaged from said first locking grooves in said spindle coupling ring for unlocking said rotary seat from said spindle coupling ring, thereby permitting operation of said rotary knob to rotate said spindle for moving said deadbolt between said locking and unlocking positions;
wherein said electric driving motor is operable to drive rotation of said rotary seat for moving said outer arc member to a second position, in which said outer arc member slides out of said one of said second locking grooves and moves along said inner peripheral surface of said stationary seat so that said seat body moves toward said inner hole end of said mounting hole against biasing action of said first spring member to cause said inner arc member to project from said inner surface of said clutch portion and engage one of said first locking grooves in said spindle coupling ring for locking said rotary seat to said spindle coupling ring, thereby enabling co-rotation of said spindle with said rotary seat for moving said deadbolt between said locking and unlocking positions; and
wherein, when said outer arc member is disposed at the second position, said manual operating member is operable so as to drive rotation of said spindle coupling ring for enabling said inner arc member to move out of said one of said first locking grooves and to slide along said outer peripheral surface of said spindle coupling ring against biasing action of said second spring member.

2. The electric door lock as claimed in claim 1, wherein at least one of said inner and outer arc members is a ball member.

3. The electric door lock as claimed in claim 1, wherein said mounting hole has a larger diameter portion proximate to said outer hole end, a smaller diameter portion proximate to said inner hole end, and a shoulder portion between said larger diameter portion and said smaller diameter portion, said seat body including a support plate disposed in said larger diameter portion, and a guide shank extending from said support plate, through said shoulder portion and into said smaller diameter portion,
said outer arc member abutting against said support plate,
said first spring member including a coil spring sleeved on said guide shank and having opposite ends that abut against said support plate and said shoulder port-ion, respectively.

4. The electric door lock as claimed in claim 3, wherein said guide shank is tubular and has said second spring member disposed therein.

5. The electric door lock as claimed in claim 4, wherein said guide shank has a constricted open end portion proximate to said inner hole end, said inner arc member being gripped releasably by said constricted open end portion of said guide shank when said outer arc member is disposed at the first position, and being forced into said guide shank against the biasing action of said second spring member when said manual operating member is operated so as to drive rotation of said spindle coupling ring while said outer arc member is disposed at the second position.

6. The electric door lock as claimed in claim 5, wherein said second spring member has a spring force sufficient to ensure engagement between said inner arc member and said spindle coupling ring when said electric driving motor is operated so as to drive rotation of said rotary seat, the spring force of said second spring member being larger than that of said first spring member.

7. The electric door lock as claimed in claim 1, wherein one of said clutch portion and said gear portion of said rotary seat is formed with a pin unit, the other one of said clutch portion and said gear portion being formed with a pinhole unit to engage said pin unit.
